(19) United States
(12) Patent Application Publication
(10) Pub. No.: US 2020/0278948 A1
(43) Pub. Date: Sep. 3, 2020

(54) METHOD, APPARATUS AND SYSTEM FOR MANAGING ELECTRONIC FINGERPRINT OF ELECTRONIC FILE

(71) Applicants: 4DREAM CO., LTD., Andong-si (KR); HANWHA TECHWIN CO., LTD., Seongnam-si (KR)

(72) Inventors: Won Kug KIM, Andong-si (KR); Ki Il RYU, Chuncheon-si (KR); Jin Kyo SHIN, Seongnam-si (KR); Kwang Rae KIM, Seoul (KR)

(73) Assignees: 4DREAM CO., LTD., Andong-si (KR); HANWHA TECHWIN CO., LTD., Seongnam-si (KR)

(21) Appl. No.: 16/880,240

(22) Filed: May 21, 2020

Related U.S. Application Data
(63) Continuation-in-part of application No. PCT/KR2018/014320, filed on Nov. 21, 2018.

(30) Foreign Application Priority Data
Nov. 24, 2017 (KR) 10-2017-0158461

(51) Int. Cl. G06F 16/14; G06F 16/11; G06F 16/13; G06F 16/17

(52) U.S. Cl. CPC G06F 16/152; G06F 16/1734; G06F 16/137; G06F 16/128

(57) ABSTRACT

A method of managing an electronic fingerprint of an electronic file includes receiving an original electronic fingerprint of an original electronic file from an original electronic file generation apparatus generating the original electronic file via a network, separately from the original electronic file; receiving original storage path information of the original electronic file together with the original electronic fingerprint from the original electronic file generation apparatus; and receiving at least one of a first identifier of the original electronic file generation apparatus and original meta information of the original electronic file together with the original electronic fingerprint from the original electronic file generation apparatus.

### TECHNICAL FIELD

The present disclosure relates to a method, apparatus and system for managing an electronic fingerprint of an electronic file.

### BACKGROUND ART

Conventionally, there are systems generating an electronic fingerprint such as a hash value of an image generated by hardware such as an image information processor and managing the electronic fingerprint together with the image information processor or in combination with the image to verify the authenticity and integrity of the image. However, a system which is capable of managing an electronic fingerprint such as a hash value of an image in an integrated manner, separately from an image information processor generating the image or the image and is thus applicable to protecting the privacy of an individual related to the image while verifying the authenticity and integrity of the image has not yet been introduced.

Furthermore, the conventional systems generating and managing an electronic fingerprint of an image are capable of managing an electronic fingerprint of an image generated by an image information processor to verify the authenticity of the image or capable of supporting a digital forensic process to use the image as evidence in a court, etc. but cannot generate and manage an electronic fingerprint of an image in connection with an image information processor generating the image.

In addition, a technical basis for not only generating and managing an electronic fingerprint such as a hash value of an image file generated by software such as an image generating program to verity the authenticity and integrity of the image file but also managing the hash value in an integrated manner separately from the software and the image file to verify the authenticity of the image file generated by the image generating program and trace illegal collection of images or use of the images other than for an original purpose is not fundamentally provided.

Accordingly, there is a need for an integrated system capable of managing an electronic fingerprint of an image in an integrated manner separately from an image information processor or image processing software generating the image to verify the authenticity and integrity of the image or fundamentally prevent infringement of the privacy of an individual due to the image.

### DETAILED DESCRIPTION OF THE INVENTION

### Technical Problem

Embodiments of the present disclosure are directed to a method, apparatus, and system for managing an electronic fingerprint of an electronic file, which are capable of managing an electronic fingerprint of an electronic file in an integrated manner separately from the electronic file to increase the efficiency of management, compared to when the electronic file is directly managed in the integrated manner, ensure public confidence in verification of the authenticity and integrity of the electronic file, and effectively prevent illegal collection, alteration, and use of the electronic file, thereby providing a basis for ensuring objective and transparent management of personal information, e.g., observance of international norms such as the General Data Protection Regulation (GDPR) established to enhance the privacy of EU citizens.

Aspects of the present disclosure are not limited thereto, and other aspects not mentioned herein will be clearly understood by those of ordinary skill in the art from the following description.

### Technical Solution

According to an embodiment of the present disclosure, a method of managing an original electronic fingerprint of an original electronic file includes receiving an original electronic fingerprint of an original electronic file from an original electronic file generation apparatus generating the original electronic file via a communication network, separately from the original electronic file; receiving original storage path information of the original electronic file together with the original electronic fingerprint from the original electronic file generation apparatus; and receiving, together with the original electronic fingerprint from the original electronic file generation apparatus, at least one of a first identifier of the original electronic file generation apparatus and original meta information of the original electronic file wherein the original electronic file is not received when the original electronic fingerprint of the original electronic file is received.

Here, the original electronic fingerprint may be generated when the original electronic file is generated or when at least part of the original electronic file is backed up.

Here, the method may further include storing at least one of the first identifier of the original electronic file generation apparatus and the original meta information of the original electronic file, which are received from the original electronic file generation apparatus, in a memory unit to be mapped to the original electronic fingerprint.

Here, the first identifier may include at least one among an Internet protocol (IP) address, a media access control (MAC) address, an identification, an installation place, an installation purpose, and a model name of the original electronic file generation apparatus.

Here, the method may further include requesting the original electronic file generation apparatus to provide the original electronic file on the basis of the original storage path information of the original electronic file, which is received from the original electronic file generation apparatus.

Here, the original electronic fingerprint may include a first original electronic fingerprint generated by the original electronic file generation apparatus during the generation of the original electronic file, and a second original electronic fingerprint generated when the original electronic file generated by the original electronic file generation apparatus is changed or deleted.

Here, the method may further include receiving a derived electronic fingerprint of a derived electronic file from a derived electronic file generation apparatus generating the derived electronic file via the network, separately from the derived electronic file, the derived electronic file being derived from the original electronic file; and outputting a result of comparing the original electronic fingerprint and the derived electronic fingerprint with each other.

According to another embodiment of the present disclosure, an apparatus for managing an original electronic fingerprint for an electronic device includes a communication unit configured to receive an original electronic fingerprint of an original electronic file from an original electronic file generation apparatus generating the original electronic file via a communication network, separately from the original electronic file; and a memory unit configured to store the original electronic fingerprint. The communication unit is further configured to receive original storage path information of the original electronic file together with the original electronic fingerprint from the original electronic file generation apparatus, and receive, together with the original electronic fingerprint from the original electronic file generation apparatus, at least one of a first identifier of the original electronic file generation apparatus and original meta information of the original electronic file, wherein the original electronic file is not received when the original electronic fingerprint of the original electronic file is received.

Here, the original electronic fingerprint may be generated when the original electronic file is generated or when at least part of the original electronic file is backed up.

Here, the apparatus may further include a processor configured to store the first identifier of the original electronic file generation apparatus, which is received from the original electronic file generation apparatus, in a memory unit to be mapped to the original electronic fingerprint.

Here, the first identifier may include at least one among an Internet protocol (IP) address, a media access control (MAC) address, an identification, an installation place, an installation purpose, and a model name of the original electronic file generation apparatus.

Here, the apparatus may further include a processor configured to request the original electronic file generation apparatus to provide the original electronic file on the basis of the original storage path information of the original electronic file, which is received from the original electronic file generation apparatus.

Here, the original electronic fingerprint may include a first original electronic fingerprint generated by the original electronic file generation apparatus during the generation of the original electronic file, and a second original electronic fingerprint generated when the original electronic file generated by the original electronic file generation apparatus is changed or deleted.

Here, the communication unit may be further configured to receive a derived electronic fingerprint of a derived electronic file from a derived electronic file generation apparatus generating the derived electronic file via the network, separately from the derived electronic file, the derived electronic file being derived from the original electronic file. The memory unit may be further configured to store the derived electronic fingerprint. The apparatus may further include a processor configured to output a result of comparing the original electronic fingerprint and the derived electronic fingerprint with each other.

According to another embodiment of the present disclosure, a system for managing an original electronic fingerprint for an electronic device includes an original electronic file generation apparatus configured to generate an original electronic file and an original electronic fingerprint of the original electronic file; and an electronic fingerprint management apparatus configured to receive the original electronic fingerprint via a communication network, separately from the original electronic file. The electronic fingerprint management apparatus is further configured to receive original storage path information of the original electronic file together with the original electronic fingerprint from the original electronic file generation apparatus, and the electronic fingerprint management apparatus is further configured to receive, together with the original electronic fingerprint from the original electronic file generation apparatus, at least one of a first identifier of the original electronic file generation apparatus and original meta information of the original electronic file, wherein the original electronic file is not received when the original electronic fingerprint of the original electronic file is received.

### Advantageous Effects of the Invention

A method, apparatus, and system for managing an electronic fingerprint of an electronic file according to an embodiment of the present disclosure are capable of managing an electronic fingerprint of an electronic file in an integrated manner separately from the electronic file to increase the efficiency of management, compared to when the electronic file is directly managed in the integrated manner, ensure public confidence in verification of the authenticity and integrity of the electronic file, and effectively prevent illegal collection, alteration, and use of the electronic file, thereby providing a basis for ensuring objective and transparent management of personal information, e.g., observance of international norms such as the general data protection regulation (GDPR) established to enhance the privacy of EU citizens.

Effects of the present disclosure are not limited thereto, and other effects not mentioned herein will be clearly understood by those of ordinary skill in the art from the following description.

### DESCRIPTION OF THE DRAWINGS

FIG. 1 is a block diagram of an apparatus for managing an electronic fingerprint of an electronic file, according to an embodiment of the present disclosure.

FIG. 2 is a diagram illustrating a method of managing an electronic fingerprint of an electronic file, according to an embodiment of the present disclosure.

FIG. 3 is a diagram illustrating a method of managing an electronic fingerprint of an electronic file, according to another embodiment of the present disclosure.

FIG. 4 is a diagram illustrating a method of managing an electronic fingerprint for an electronic file, according to another embodiment of the present disclosure.

FIG. 5 is a diagram illustrating a method of verifying authenticity of an image copy of an image information processor, according to an embodiment of the present disclosure.

FIG. 6 is a diagram illustrating a method of preventing distribution of an illegally captured image, according to an embodiment of the present disclosure.

### MODE OF THE INVENTION

Hereinafter, embodiments of the present disclosure will be described in detail with reference to the accompanying drawings. However, it will be apparent to those of ordinary skill in the art that the accompanying drawings are merely provided to help understanding of the present disclosure and thus the scope of the present disclosure is not limited thereby.

The terminology used herein is for the purpose of describing particular embodiments only and is not intended to limit the present disclosure. As used herein, the singular forms “a”, “an” and “the” are intended to include the plural forms as well, unless the context clearly indicates otherwise.

It will be further understood that the terms “comprise” and/or “comprising,” when used in this specification, specify the presence of stated features, integers, steps, operations, elements, components, or a combination thereof but do not preclude the presence or addition of one or more other features, integers, steps, operations, elements, components, or a combination thereof.

An apparatus and method for managing an electronic fingerprint of an electronic file according to an embodiment of the present disclosure will be described with reference to the drawings below.

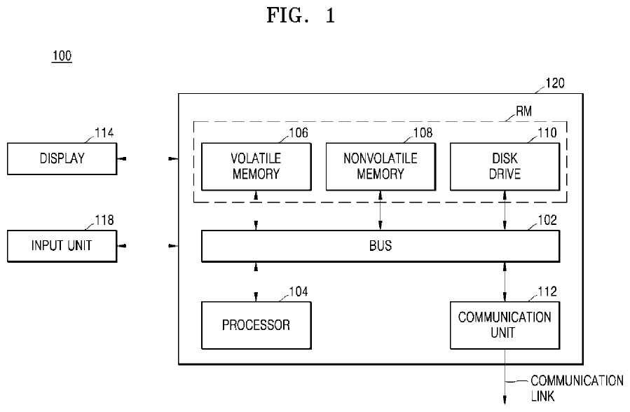

FIG. 1 illustrates an electronic fingerprint management apparatus 100 for managing an electronic fingerprint of an electronic file, according to an embodiment of the present disclosure. As illustrated in FIG. 1, the electronic fingerprint management apparatus 100 according to an embodiment of the present disclosure may include a bus 102 or another communication mechanism to transmit information.

The bus 102 or the other communication mechanism connects a processor 104, a memory unit RM which is a computer-readable recording medium, a communication unit 112 including a local area network (e.g., Bluetooth or near-field communication (NFC)), a network interface or a mobile communication module, a display 114 (e.g., a video adapter, a cathode ray tube (CRT), or a liquid crystal display (LCD)), an input unit 118 (e.g., a keyboard, a keypad, a virtual keyboard, a mouse, a trackball, a stylus, or a touch sensing means), and/or subsystems.

The memory unit RM includes, but is not limited to, a volatile memory 106 (e.g., a RAM), a nonvolatile memory 108 (e.g., a ROM), and a disk drive 110 (e.g., an HDD, an SSD, an optical disc, or a flash memory drive).

In this case, the disk drive may be a non-transitory recording medium. The optical disc may be a CD, a DVD, or a Blu-ray disc but is not limited thereto. The electronic fingerprint management apparatus 100 according to an embodiment of the present disclosure may include one or more disk drives 110.

As illustrated in FIG. 1, the disk drive 110 may be included in a housing 120 together with the processor 104 but may be installed remotely from the processor 104 and remote communication may be established between the disk drive 110 and the processor 104. The one or more disk drives 110 may store a database.

The memory unit RM may store an operating system, a driver, an application program, data, a database, etc. needed to operate the electronic fingerprint management apparatus 100 according to an embodiment of the present disclosure.

The display 114 may display an operation interface of the electronic fingerprint management apparatus 100 according to an embodiment of the present disclosure and a user interface.

The processor 104 may be, but is not limited to, a central processing unit (CPU), an application processor (AP), a microcontroller, a digital signal processor, (DSP), or the like, and controls an operation of the electronic fingerprint management apparatus 100 according to an embodiment of the present disclosure.

The processor 104 controls an operation of the electronic fingerprint management apparatus 100 according to an embodiment of the present disclosure which will be described below by being connected to the memory unit RM and executing instructions or one or more sequences of logic stored in the memory unit RM.

The instructions may be read out to the volatile memory 106 from a computer-readable recording medium such as the nonvolatile memory 108 or the disk drive 110. In other embodiments, hard-wired circuitry replacing software instructions implementing the present disclosure or included in hardware combined with the software instructions may be used.

The logic may refer to a medium participating in providing instructions to the processor 104, and may be encoded in the memory unit RM.

The processor 104 may communicate with a hardware controller for the display 114 to display the operation of the electronic fingerprint management apparatus 100 and a user interfacing operation on the display 114.

Transmission media including wires of the bus 102 may include coaxial cables, copper wires, and optical fibers. For example, the transmission media may be in the form of sound waves or light waves generated during radio wave communication or infrared data communication.

Examples of the memory unit RM may include a floppy disk, a flexible disk, a hard disc, a magnetic tape, various types of magnetic media, a CD-ROM, various types of optical media, punch cards, paper tape, various types of physical media with hole patterns, a RAM, a PROM, an EPROM, a flash-EPROM.

In various embodiments of the present disclosure, execution of instruction sequences to implement the present disclosure may be performed by the electronic fingerprint management apparatus 100 according to an embodiment of the present disclosure. In various other embodiments of the present disclosure, the instruction sequences for implementing the present disclosure may be performed in cooperation with a plurality of computing devices connected via a communication link (e.g., an LAN, a WLAN, a PTSN, and/or other wired or wireless networks including telecommunication, mobile, and cellular phone networks).

The electronic fingerprint management apparatus 100 according to an embodiment of the present disclosure may transmit and receive instructions, including messages, data, information, and one or more programs (i.e., application code), via the communication link and the communication unit 112.

The communication unit 112 may include a separate or integrated antenna for transmission and reception via the communication link. The communication unit 112 may include at least one among a local area communication module, a network interface, and a mobile communication module. The local area communication module may be a Bluetooth communication module, an NFC module, or an infrared communication module but is not limited thereto. The mobile communication module may be connected to generation-specific mobile communication networks (e.g., 2G to 5G mobile communication networks).

Program code may be executed by the processor 104 when received, and/or may be stored in the disk drive 110 or other nonvolatile memories for the execution of the program code.

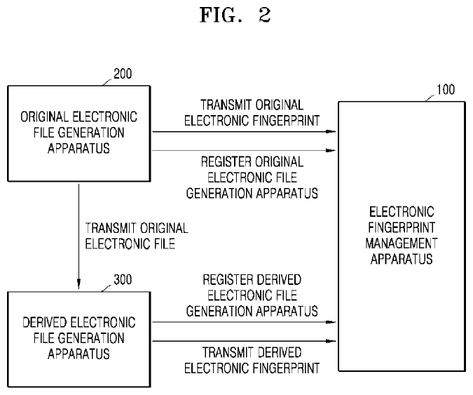

FIG. 2 is a diagram illustrating a method of managing an electronic fingerprint of an electronic file, according to an embodiment of the present disclosure. Although it will be described below that the method of managing an electronic fingerprint of an electronic file according to an embodiment of the present disclosure is performed by the electronic fingerprint management apparatus 100 according to an embodiment of the present disclosure, the method is not limited thereto.

An original electronic fingerprint of an original electronic file is received from an original electronic file generation apparatus 200 generating the original electronic file via a network. In an embodiment of the present disclosure, the original electronic file generation apparatus 200 may be a network camera, a network video recorder (NVR), a digital video recorder (DVR), a black box for a vehicle, a smartphone, a desktop computer, a laptop computer, or a tablet PC but is not limited thereto.

The original electronic file and a derived electronic file which will be described below may include video files, image files, document files (e.g., PDF files, Microsoft Word files, Hangul files, etc.), design files (e.g., 3dmax files or Auto CAD files) but are not limited thereto.

The original electronic file generation apparatus 200 may generate an original electronic fingerprint of the original electronic file.

For example, the original electronic file generation apparatus 200 may generate a hash value of the original electronic file through a hash function and thus the original electronic fingerprint may include the hash value of the original electronic file.

When an electronic file is a video, the hash value thereof may be generated in a file unit or in units of frames (a group of videos) in which the video is stored or may be generated in certain time units. In this case, information regarding the file, the frames, or the time units, e.g., image size, file name, and a time correction value, may be additionally generated in connection with the hash value.

If the original electronic file generation apparatus 200 is a camera, the hash value may be generated when the video is captured. If the original electronic file generation apparatus 200 is a storage device, the hash value may be generated when the electronic device is generated and stored and/or when at least part of the stored electronic file is backed up to an external device.

When the original electronic file generation apparatus 200 is an NVR, the NVR may receive a captured original image file from a network camera and store the original image file in real time. An original hash value of the original image file may be generated in a unit of an electronic file. When a plurality of original image files are generated, original hash values corresponding to the plurality of original image files may be generated and transmitted to the electronic fingerprint management apparatus 100.

When an investigation agency or the like backs up an entire specific original image file among a plurality of original image files stored in the NVR through a derived electronic file generation apparatus 300, the derived electronic file generation apparatus 300 may generate a derived hash value of a backed-up derived image file and transmit the derived hash value to the electronic fingerprint management apparatus 100. The electronic fingerprint management apparatus 100 may verify the authenticity of the derived image file by checking whether the derived hash value transmitted thereto is identical to the original hash value stored therein.

When the investigation agency or the like backs up only an image of a section of the specific original image file stored in the NVR through the derived electronic file generation apparatus 300, the NVR may newly generate an original hash value of the backed-up image of the section of the specific original image file and transmit the newly generated original hash value to the electronic fingerprint management apparatus 100. The derived electronic file generation apparatus 300 may generate a derived hash value of a backed-up derived image file and transmit the derived hash value to the electronic fingerprint management apparatus 100 before the backed-up derived image file will be used as evidence hereinafter. The electronic fingerprint management apparatus 100 may verify the authenticity of the derived image file by checking whether the original hash value of the image of the section of the original image file received from the NVR and the derived hash value of the derived image file received from the derived electronic file generation apparatus 300 are identical to each other.

When the original electronic file is transmitted to another device connected through communication, the other device receiving the original electronic file may generate an original electronic fingerprint of the original electronic file. For example, when an image file generated by a surveillance camera is stored in an image storage device or when a stored image file is backed up to an external device, an original electronic fingerprint of the image file may be generated.

The original electronic file generation apparatus 200 generates an original electronic fingerprint of an original electronic file and transmits the original electronic fingerprint to the electronic fingerprint management apparatus 100 via a network. Accordingly, the original electronic fingerprint can be managed separately from the original electronic file, thereby ensuring the reliability of the verification of the authenticity and integrity of the original electronic file and effectively preventing unauthorized collection, alteration, and use of the original electronic file. Thus, it is possible to provide a basis for ensuring objective and transparent management of the movement of personal information, e.g., compliance with international norms such as the General Data Protection Regulation (GDPR) established to strengthen the privacy of EU citizens.

When the original electronic fingerprint is managed in combination with the original electronic file, the original electronic fingerprint is individually managed to be generated, changed, and stored together with the original electronic file. Thus, the objectivity of the original electronic fingerprint is low and is deleted when the original electronic file is deleted, thereby preventing verification of the authenticity of an electronic file derived from the original electronic file. In contrast, if the original electronic fingerprint is managed by a device, such as a server gaining public confidence, separately from the original electronic file, the objectivity of the original electronic fingerprint may be secured, and the authenticity of an electronic file derived from the original electronic file is may be objectively verified even when the original electronic file is deleted.

Furthermore, if an original electronic fingerprint is generated and managed separately from an original electronic file during the generation or deletion of the original electronic file, a change in a life cycle of the original electronic file may be identified on the basis of the original electronic fingerprint. Accordingly, when the same type of electronic file is changed contrary to the change in the life cycle, whether the electronic file is abused may be determined and thus the electronic file may be efficiently managed.

The network via which the original electronic fingerprint of the original electronic file is transmitted may be, but is not limited to, a closed network, an in-house network, a common network, a local network, the Internet, a mobile communication network, or a combination thereof.

The derived electronic file generation apparatus 300 may receive an original electronic file from the original electronic file generation apparatus 200. In this case, the derived electronic file generation apparatus 300 may be, but is not limited to, a device for verifying or investigating an original electronic file, such as a digital forensic collection device, a CCTV control server, a server of the National Forensic Service, or the like.

The derived electronic file generation apparatus 300 may generate a derived electronic file which is a copy of the original electronic file from the original electronic file. Furthermore, the derived electronic file generation apparatus 300 generates a derived electronic fingerprint of the derived electronic file, and the electronic fingerprint management apparatus 100 receives the derived electronic fingerprint of the derived electronic file via the network. In this case, the derived electronic fingerprint may be stored in connection with the original electronic fingerprint or original meta information of the original electronic file.

For example, the derived electronic file generation apparatus 300 may generate a derived hash value of a derived image file through a hash function and thus the derived electronic fingerprint may include the derived hash value of the derived image file. The derived electronic fingerprint may further include an original hash value or original meta information of the original image file.

A plurality of derived electronic fingerprints may be generated for the same specific original electronic file by a plurality of derived electronic file generation apparatuses 300. For example, a digital forensic collection device of an investigation agency which generates a first derived electronic file for a specific original electronic file may be a first derived electronic file generation apparatus, a derived electronic fingerprint generated by the first derived electronic file generation apparatus is a first derived electronic fingerprint, a collection device of a judicial authority which generates a second derived electronic file for the same specific original electronic file may be a second derived electronic file generation apparatus, and a derived electronic fingerprint generated by the second derived electronic file generation apparatus is a second derived electronic fingerprint. The first and second derived electronic file generation apparatuses may transmit identification information thereof together with the first and second derived electronic fingerprints to the electronic fingerprint management apparatus 100. Thus, the electronic fingerprint management apparatus 100 may manage a history of providing a plurality of derived electronic files with respect the specific original electronic file in an integrated manner.

As described above, the electronic fingerprint management apparatus 100 may receive an original electronic fingerprint of an original electronic file from the original electronic file generation apparatus 200, and receive a derived electronic fingerprint of a derived electronic file from the derived electronic file generation apparatus 300. The original electronic fingerprint and the derived electronic fingerprint may be stored in a database in the memory unit RM.

In this case, the electronic fingerprint management apparatus 100 produces a result of comparing the original electronic fingerprint and the derived electronic fingerprint with each other. For example, the original electronic file generation apparatus 200 may transmit original electronic fingerprints for respective original image files generated periodically or on a specific file basis to the electronic fingerprint management apparatus 100.

The electronic fingerprint management apparatus 100 may be any of various types of devices capable of receiving an original electronic fingerprint and a derived electronic fingerprint from the original electronic file generation apparatus 200 and the derived electronic file generation apparatus 300. For example, the electronic fingerprint management apparatus 300 may be a cloud-based server. That is, the electronic fingerprint management apparatus 100 may be a public cloud server when a network via which the original electronic fingerprint and the derived electronic fingerprint are transmitted is a common network such as the Internet, and may be a private cloud server when the network is a closed network such as a dedicated network. When the network via which the original electronic fingerprint and the derived electronic fingerprint are transmitted is a hybrid network which is a combination of the closed network and the common network, the electronic fingerprint management apparatus 100 may be a hybrid cloud server, e.g., a combination of a private cloud server included in a CCTV control center and an external public cloud server. In this case, electronic fingerprints may be primarily collected by the private cloud server and then be secondarily and finally collected by the public cloud server.

Even if the original electronic fingerprint is stored and managed separately from the original electronic file generation apparatus 200, the original electronic fingerprint cannot be reliably verified when handled by a non-reputable electronic fingerprint management apparatus. Accordingly, the electronic fingerprint management apparatus 100 is preferably operated and managed in an integrated manner by a reputable institution such as a national institution to systemize an authentication procedure for generation of video evidence.

In this case, the derived electronic file generation apparatus 300 may receive, from the original electronic file generation apparatus 200, an original electronic file corresponding to evidence of a criminal case or documentary evidence of a contract and generated at a specific time point in the past. A person or an institute managing the derived electronic file generation apparatus 300 should verify the authenticity of the received original electronic file and thus may transmit a derived electronic fingerprint thereof for the verification of the original electronic file.

Thus, the electronic fingerprint management apparatus 100 may verify the authenticity of the original electronic file by comparing the derived electronic fingerprint with an original electronic fingerprint previously stored therein. In this case, when the derived electronic fingerprint is related to the original electronic fingerprint or original meta information of the original electronic file, the original electronic fingerprint or the original meta information may be used for the verification of the authenticity of the original electronic file.

Although the electronic fingerprint management apparatus 100 respectively receives the original electronic fingerprint and the derived electronic fingerprint from the original electronic file generation apparatus 200 and the derived electronic file generation apparatus 300, the original electronic fingerprint and the derived electronic fingerprint may be managed independently from the original electronic file generation apparatus 200 and the derived electronic file generation apparatus 300 after the original electronic fingerprint and the derived electronic fingerprint are received.

In addition, the electronic fingerprint management apparatus 100 may have various additional functions. For example, the electronic fingerprint management apparatus 100 may issue identifications (IDs) of all devices transmitting an original electronic fingerprint so that the authenticity of the electronic file may be verified only for the devices having the ID.

In an electronic fingerprint management method according to an embodiment of the present disclosure, the original electronic file generation apparatus 200 may generate a first identifier for a device together with an original electronic fingerprint of an original electronic file and transmit the first identifier together with the original electronic fingerprint to the electronic fingerprint management apparatus 300. The electronic fingerprint management apparatus 300 may receive the original electronic fingerprint and a plurality of first identifiers, and store the original electronic fingerprint and the first identifiers in the memory unit RM to be mapped to each other. In this case, the first identifiers may include at least one among an Internet protocol (IP) address, a media access control (MAC) address, and identification information such as an ID of the original electronic file generation apparatus 200, a device name or a model name (e.g., a CCTV camera, a black box camera, a wearable camera, a smartphone camera, or a drone camera), an installation place, and an installation purpose.

The original electronic fingerprint may be generated and collected in an electronic file having a standard format, together with the first identifier. In particular, when the standard format is applied to an image capturing device installed for a common purpose, it is possible to objectively and easily identify an image, the image capturing device (e.g., a CCTV camera, a black box camera, a wearable camera, a smartphone camera, or a drone camera), an installation place of the image capturing device, and time when the image was generated or backed up by checking only the electronic file.

Based on the IP address of the original electronic file generation apparatus 200, whether a site at which an apparatus capturing an original image is installed or whether an image file stored in a cloud server has been damaged may be verified. For example, when an original electronic fingerprint of an original CCTV image captured by a CCTV installed in a place of crime has been transmitted to and stored in an electronic fingerprint management apparatus, whether the original CCTV image has been damaged may be verified by generating an electronic fingerprint of a CCTV image (corresponding to a derived electronic file) stored in an image capturing device having a corresponding IP address just before CCTV images which may be clues for the crime are collected (backed up) and comparing the electronic fingerprint with the original electronic fingerprint. If the original CCTV image has been damaged, a course of investigation may be added with respect to an insider who have destroyed video evidence.

The derived electronic file generation apparatus 300 may generate a second identifier for a device together with a derived electronic fingerprint of a derived electronic file, and transmit the second identifier together with the derived electronic fingerprint to the electronic fingerprint management apparatus 100. The electronic fingerprint management apparatus 100 may receive the derived electronic fingerprint and the second identifier, and store the derived electronic fingerprint and the second identifier in the memory unit RM to be mapped to each other. Similarly, the second identifier may include at least one among an IP address, a MAC address, and an ID of the derived electronic file generation apparatus 300.

Accordingly, a plurality of original electronic fingerprints generated by a plurality of original electronic file generation apparatuses 200 may be effectively managed using the first identifier, and a plurality of derived electronic fingerprints generated by a plurality of derived electronic file generation apparatuses 300 may be compared with the plurality of original electronic fingerprints and the first identifier by using the second identifier to effectively identify whether the plurality of derived electronic fingerprints are identical to the plurality of original electronic fingerprints.

The original electronic file generation apparatus 200 may generate original meta information of an original electronic file, transmit the original meta information together with an original electronic fingerprint of the original electronic file to the electronic fingerprint management apparatus 100. The electronic fingerprint management apparatus 100 may store the original electronic fingerprint and the original meta information in the memory unit RM to be mapped to each other. In this case, the original meta information may include date and time when an original image file is generated, date and time when the original electronic fingerprint is generated, the title or ID of the original image file, the type of the original image file, file size, file generation coordinates (GPS coordinates, GLONASS coordinates, or the like), etc.

The derived electronic file generation apparatus 300 may generate derived meta information of a derived electronic file and transmit the derived meta information together with a derived electronic fingerprint of the derived electronic file to the electronic fingerprint management apparatus 100. The electronic fingerprint management apparatus 100 may store the derived electronic fingerprint and the derived meta information in the memory unit RM to be mapped to each other. In this case, the derived meta information may include date and time when the derived image file is generated, date and time when the derived electronic fingerprint is generated, the title or ID of the derived image file, the type of the derived image file, the title or ID of an original image file corresponding to the derived image file, the type of the original image file, a first identifier of the original image file corresponding to the derived image file, etc.

Accordingly, a plurality of original electronic fingerprints generated by the original electronic file generation apparatus 200 may be effectively managed using the original meta information, and a plurality of derived electronic fingerprints generated by the derived electronic file generation apparatus 300 may be compared with the plurality of original electronic fingerprints and the original meta information by using the derived meta information to effectively identify whether the plurality of derived electronic fingerprints are identical to the plurality of original electronic fingerprints.

Furthermore, the original electronic file generation apparatus 200 may generate a first identifier for a device together with an original electronic fingerprint of an original electronic file, generate original meta information of the original electronic file, and transmit the first identifier and the original meta information together with the original electronic fingerprint to the electronic fingerprint management apparatus 300. The electronic fingerprint management apparatus 300 may store the first identifier and the original meta information in the memory unit RM to be mapped to the original electronic fingerprint.

The derived electronic file generation apparatus 300 may generate a second identifier for a device together with a derived electronic fingerprint of a derived electronic file, generate derived meta information of the derived electronic file, and transmit the second identifier and the derived meta information together with the derived electronic fingerprint to the electronic fingerprint management apparatus 300. The electronic fingerprint management apparatus 300 may store the second identifier and the derived meta information in the memory unit RM to be mapped to the derived electronic fingerprint.

Thus, a plurality of original electronic fingerprints generated by a plurality of original electronic file generation apparatuses 200 may be efficiently managed using the first identifier and the original meta information, and a plurality of derived electronic fingerprints generated by a plurality of derived electronic file generation apparatuses 300 may be compared with the plurality of original electronic fingerprints, the first identifier, and the original meta information by using the second identifier and the derived meta information to effectively identify whether the plurality of derived electronic fingerprints are identical to the plurality of original electronic fingerprints.

The electronic fingerprint management apparatus 300 may store, in a standard format, the first and second identifiers, the original meta information, and derived meta information collected from the original electronic file generation apparatus 200 and the derived electronic file generation apparatus 300. Accordingly, the collected information may be efficiently collected and managed.

In addition, the first identifier and the second identifier may be stored in the electronic fingerprint management apparatus 100 during registration of the original electronic file generation apparatus 200 and the derived electronic file generation apparatus 300 with the electronic fingerprint management apparatus 100.

The electronic fingerprint management method according to an embodiment of the present disclosure may further include receiving original storage path information of the original electronic file together with the original electronic fingerprint from the original electronic file generation apparatus 200 storing the original electronic file, and requesting the original electronic file generation apparatus 200 to provide the original electronic file on the basis of the original storage path information.

In this case, the original storage path information may include uniform resource locator (URL) information of the original electronic file. The original electronic fingerprint may be linked to the original electronic file stored in the original electronic file generation apparatus 200 according to the URL information.

Accordingly, whether there is an electronic file linked to the electronic fingerprint management apparatus 100 is checked, and when there is an electronic file linked to the electronic fingerprint management apparatus 100, the authenticity of the electronic file may be quickly verified by generating an electronic fingerprint of the linked electronic file and comparing the electronic fingerprint with the electronic fingerprint stored in the electronic fingerprint management apparatus 100. For example, when the electronic file linked to the electronic fingerprint management apparatus 100 is an electronic file of a contract image, whether the authenticity of the contract image of the linked electronic file may be quickly verified by generating a hash value of the contract image and comparing the hash value with that stored in the electronic fingerprint management apparatus 100.

The electronic fingerprint management method according to an embodiment of the present disclosure may further include receiving derived storage path information of a derived electronic file together with a derived electronic fingerprint from the derived electronic file generation apparatus 300 storing the derived electronic file, and requesting the derived electronic file generation apparatus 300 to provide the original electronic file on the basis of the derived storage path information.

Similarly, the derived storage path information may include URL information of the derived electronic file. The derived electronic fingerprint may be linked to the derived electronic file stored in the derived electronic file generation apparatus 300 according to the URL information.

As described above, in an electronic fingerprint management method according to an embodiment of the present disclosure, an original electronic file or a derived electronic file may not be stored in the electronic fingerprint management apparatus 100. Accordingly, there may be a large number of original electronic file generation apparatuses 200, and thus it is possible to prevent an excessive increase in the storage capacity of the electronic fingerprint management apparatus 100, caused when original electronic files are received from the original electronic file generation apparatuses 200 and are stored in the electronic fingerprint management apparatus 100.

The original electronic file or the derived electronic file may be copyrighted or confidential data and thus a person or an organization that owns the original electronic file or the derived electronic file may be reluctant to store the original electronic file or the derived electronic file in the electronic fingerprint management apparatus 100. Thus, the original electronic file or the derived electronic file can be linked to only after receiving permission from the owner or the organization thereof.

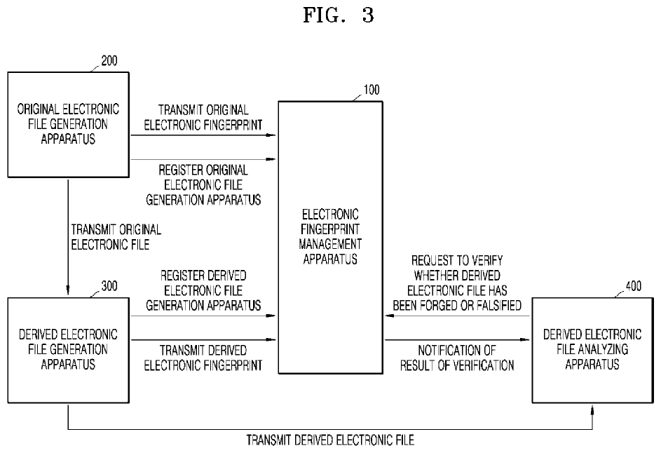

As illustrated in FIG. 3, an electronic fingerprint management method according to another embodiment of the present disclosure may further include transmitting a result of comparing an original electronic fingerprint and a derived electronic fingerprint with each other to a derived electronic file analyzing apparatus 400, in response to a request to verify whether the derived electronic file has been forged or falsified, received from a derived electronic file analyzing apparatus 400.

The derived electronic file analyzing apparatus 400 may be a forensic analysis server belonging to an organization, a group, or an individual that needs the integrity of a derived electronic file to be verified, and may be mainly configured to analyze the derived electronic file to be used as evidence.

The derived electronic file analyzing apparatus 400 may receive a derived electronic file from the derived electronic file generation apparatus 300. In this case, the derived electronic file analyzing apparatus 400 may receive meta information of the derived electronic file and a second identifier of the derived electronic file generation apparatus 300 generating the meta information and the derived electronic file.

It is important to verify whether the derived electronic file has been forged or falsified, so that the derived electronic file analyzing apparatus 400 may identify whether the derived electronic file is available as evidence. Thus, the derived electronic file analyzing apparatus 400 may request the electronic fingerprint management apparatus 100 to verify whether the derived electronic file has been forged or falsified.

To this end, the derived electronic file analyzing apparatus 400 may transmit the received meta information of the derived electronic file to the electronic fingerprint management apparatus 100, and the electronic fingerprint management apparatus 100 may verify whether the derived electronic file has been forged or falsified by comparing a derived electronic fingerprint of the derived electronic file corresponding to the meta information of the derived electronic file with an original electronic fingerprint of an original electronic file, and inform the derived electronic file analyzing apparatus 400 of a result of the verification, in response to the request. The derived electronic fingerprint may be related to the original electronic fingerprint or the original meta information of the original electronic file. In this case, the original electronic fingerprint or the original meta information related to the derived electronic fingerprint may be used in determining whether the derived electronic file has been forged or falsified.

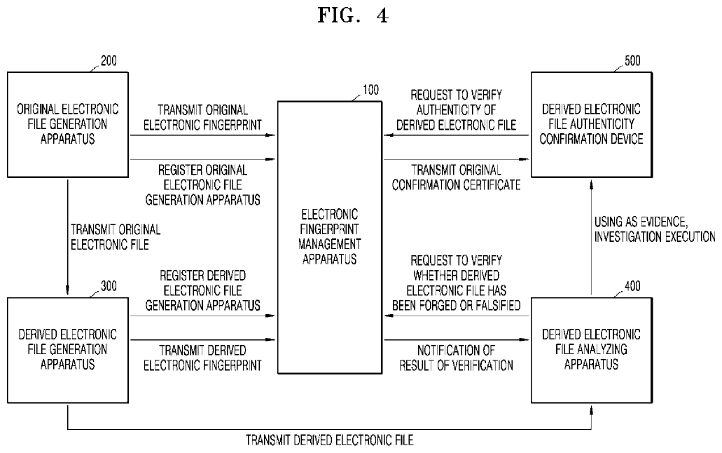

As illustrated in FIG. 4, an electronic fingerprint management method according to another embodiment of the present disclosure may further include transmitting an original confirmation certificate to a derived electronic file authenticity confirmation device 500, in response to a request to verify the authenticity of a derived electronic file, received from the derived electronic file authenticity confirmation device 500.

In this case, the derived electronic file authenticity confirmation device 500 may receive a notification informing that the derived electronic file will be used as evidence on the basis of the result of the comparison described above with reference to FIG. 3 from the derived electronic file analyzing apparatus 400. In this case, the derived electronic file authenticity confirmation device 500 may is transmitted the meta information and the second identifier of the derived electronic file from the derived electronic file analyzing apparatus 400.

The derived electronic file analyzing apparatus 400 may be a prosecution server, a police server, or a court server belonging to an organization, an institute, or an individual that needs to verify the integrity of the derived electronic file.

When the prosecution, the police, or the court receives, from the derived electronic file analyzing apparatus 400, a notification informing that the derived electronic file will be used as evidence, the prosecution, the police, or the court may request the electronic fingerprint management apparatus 100 to provide an original confirmation certificate certifying the authenticity of the derived electronic file. In this case, the derived electronic file authenticity confirmation device 500 may transmit the second meta information and the second identifier to the electronic fingerprint management apparatus 100.

Accordingly, the electronic fingerprint management apparatus 100 may transmit the original confirmation certificate containing a result of comparing a derived electronic fingerprint with an original electronic fingerprint to the derived electronic file authenticity confirmation device 500.

The electronic fingerprint management apparatus 100 according to an embodiment of the present disclosure includes the communication unit 112, the memory unit RM, and the processor 104.

The communication unit 112 receives an original electronic fingerprint of an original electronic file from the original electronic file generation apparatus 200 generating the original electronic file via a network, and receives a derived electronic fingerprint of a derived electronic file derived from the original electronic file from the derived electronic file generation apparatus 300 generating the derived electronic file via the network. The derived electronic fingerprint may be related to the original electronic fingerprint.

The memory unit RM stores the original electronic fingerprint and the derived electronic fingerprint. The memory unit RM and the processor 104 may be included in one housing 120 but may be included in different housings separated spatially.

The processor 104 outputs a result of comparing the original electronic fingerprint and the derived electronic fingerprint with each other. When the processor 104 and the memory unit RM are included in different housings, the processor 104 may be connected to the memory unit RM via the communication unit 112.

The original electronic fingerprint may include a hash value of the original electronic file, and the derived electronic fingerprint may include a hash value of the derived electronic file. The original electronic fingerprint, the derived electronic fingerprint, and the hash values thereof have been described in detail above and are thus not redundantly described here.

The processor 104 may receive a first identifier of the original electronic file generation apparatus 200, store the first identifier in the memory unit RM to be mapped to the original electronic fingerprint, receive a second identifier of the derived electronic file generation apparatus 300, and store the second identifier in the memory unit RM to be mapped to the derived electronic fingerprint. The first identifier, the second identifier, and the meta information have been described in detail above and are thus not redundantly described here.

The processor 104 may receive original storage path information of the original electronic file together with the original electronic fingerprint from the original electronic file generation apparatus 200 storing the original electronic file, and may request the original electronic file generation apparatus 200 to provide the original electronic file on the basis of the original storage path information.

In addition, the processor 104 may receive derived storage path information of the derived electronic file together with the derived electronic fingerprint from the derived electronic file generation apparatus 300 storing the derived electronic file, and may request the derived electronic file generation apparatus 300 to provide the derived electronic file on the basis of the derived storage path information.

Accordingly, the electronic fingerprint management apparatus 100 according to an embodiment of the present disclosure need not store the original electronic file and the derived electronic file in the memory unit RM and thus an excessive increase in the capacity of the memory unit RM may be prevented and a copyright or security condition may be satisfied.

As described above with reference to FIGS. 2 to 4, a system for managing an electronic fingerprint of an electronic file according to an embodiment of the present disclosure includes the original electronic file generation apparatus 200, the derived electronic file generation apparatus 300, and the electronic fingerprint management apparatus 100.

The original electronic file generation apparatus 200 generates an original electronic file and an original electronic fingerprint of the original electronic file.

The derived electronic file generation apparatus 300 generates a derived electronic file derived from the original electronic file, and a derived electronic fingerprint of the derived electronic file. The derived electronic fingerprint may be connected with the original electronic fingerprint or original meta information of the original electronic file.

The electronic fingerprint management apparatus 100 receives the original electronic fingerprint and the derived electronic fingerprint via a network and outputs a result of comparing the original electronic fingerprint and the derived electronic fingerprint with each other. In this case, when the derived electronic fingerprint is connected with the original electronic fingerprint of the original electronic file or the original meta information, the original electronic fingerprint or the original meta information may be used for the comparison of the derived electronic fingerprint with the original electronic fingerprint.

As illustrated in FIG. 3, the system for managing an electronic fingerprint of an electronic file according to an embodiment of the present disclosure may further include the derived electronic file analyzing apparatus 400 requesting the electronic fingerprint management apparatus 100 to verify whether the derived electronic file has been forged or falsified. The electronic fingerprint management apparatus 100 may transmit the result of comparing the original electronic fingerprint and the derived electronic fingerprint to the derived electronic file analyzing apparatus 400.

Furthermore, as illustrated in FIG. 4, the system for managing an electronic fingerprint of an electronic file according to an embodiment of the present disclosure may further include the derived electronic file authenticity confirmation device 500 requesting the electronic fingerprint management apparatus 100 to verify the authenticity of the derived electronic file, when receiving a notification informing that the derived electronic file will be used as evidence from the derived electronic file analyzing apparatus 400.

In this case, the electronic fingerprint management apparatus 100 may transmit an original confirmation certificate to the derived electronic file authenticity confirmation device 500 according to the result of the comparison.

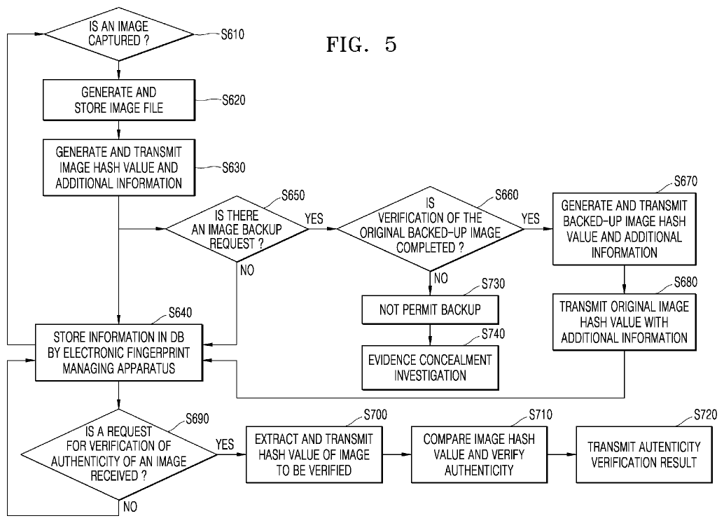

FIG. 5 is a diagram illustrating a method of verifying authenticity of an image copy of an image information processor, according to an embodiment of the present disclosure.

An image information processor captures images (S610). Then, the image information processor generates and stores one or more image files (S620). When an image file is generated by the image information processor, an image hash value and additional information, including but not limited to, an image storing path, device identification information (IP address, MAC address, model name, installation apparatus, installation purpose) and image meta information (hash value generation date and time, and generation date and time, name, type, size, and generation coordinates of the image file) are generated together (S630). Then, while the image file is not transmitted, the image hash value, the image storing path, the device identification information, and the image meta information are transmitted to an electronic fingerprint managing apparatus and the electronic fingerprint managing apparatus stores the image hash value, the image storing path, the device identification information, and the image meta information in a database (S640).

The “generation” of an image file may mean that an image is captured not only by a fixed type camera such as a CCTV camera, but also by a mobile camera such as a black box camera, a drone camera, a smartphone camera, or a Google glass, that the captured image is stored in a storage device such as an NVR, a VMS, or a computer that receives the captured image, or that a portion of a particular stored image file is backed up in a storage medium such as a USB. In addition, the “generation” of an image file may include generating an image file by scanning a paper document by using a document scanner. A video that is continuously captured by a CCTV may be generated by being divided into many image files depending on a certain standard such as a file size, a time period, or an event.

The image hash value may be transmitted together with at least one from the group consisting of an image storing path, device identification information, and image meta information.

When an investigative agency such as the prosecution backs up in a forensic USB a portion or the whole of a specific image file from the image information processor such as a camera or a storage device (S650), the image hash value, the image storing path, the device identification information, and the image meta information are generated regarding the backed-up image file for authenticity verification and transmitted to the electronic fingerprint managing apparatus (S660, S670). At this time, an image hash value of the original image file from which the backed-up image file is generated and additional information, i.e., the image storing path, the device identification information, and the image meta information of the original image file may be transmitted together (S680). Then, when the prosecution submits the backed-up copy of image file to the court as evidence of a trial, the court requests the electronic fingerprint managing apparatus to evaluate the authenticity of the submitted image copy.

When receiving the image copy authenticity verification request (S690), the electronic fingerprint managing apparatus generates an image hash value and image meta information regarding the image copy received from the court server and searches for the presence of the same image on the basis of the image hash value and image meta information stored in a database (S700, S710). The electronic fingerprint managing apparatus determines the authenticity of the image on the basis of whether the same image hash value as the image copy exists and transmits a result thereof to the court server (S720). In this case, it is proven whether there is forgery and alteration in the image file from when the image is backed up for evidence collection from the image information processor to when the image is submitted to the court. Whether the forgery and alteration of an original image file had been committed from when the images were created in the image information processor to when the image was submitted to the court as an evidence may be verified by generating a hash value of the image file at the time of being initially created, transmitting the hash value to the electronic fingerprint managing apparatus, generating a hash value of image file at the time of being backed up and comparing with the previously stored hash value for verification of the authenticity. Then, the backup is permitted only when the verification is completed.

When the authenticity of the backed-up image is not verified, the backup is not permitted (S730). Then, the prosecution may switch the investigation to an evidence concealment investigation (S740).

As images are created or stored in the image information processor, the image hash value for every single image file is generated and separately transmitted to the electronic finger electronic fingerprint. Accordingly, when the specific image file as a whole stored in the image information processor is backed up, whether the forgery and alteration of the image file had been committed from when the image was created or stored in the image information processor to when the image was submitted to the court as an evidence may be verified.

When a hash value of a backed-up image copy is generated and transmitted to the electronic fingerprint managing apparatus, an image hash value of an image file from which the backed-up image copy is made may be transmitted alone or together with an image storing path, device identification information, and image meta information. That is, every time image file is created, modified, excerpted or deleted, the hash value of a derived image file is referenced with that of an original image file from which the derived image file is made. Accordingly, tracking and management of an image providing history such as generation, backup, forgery and alternation, composition, and erasure of an image during an entire life cycle of the image is possible. Furthermore, even when a portion of a specific image file is backed up from the image information processor for evidence collection, it may be proven whether the forgery and alteration of the image file had been committed from the time of the first storing time of the image in the image information processor to the time when the image was submitted to the court as an evidence.

In the case of the image information processor such as a drone camera or an unmanned aerial vehicle (UAV) camera, when a video file is generated by being captured in real time and stored in a storage, an image hash value, device identification information, and image meta information may be transmitted to the electronic fingerprint managing apparatus and stored therein. The electronic fingerprint managing apparatus may uncover illegal aerial images captured without prior authorization on the basis of the device identification information and the image meta information.

The court determines whether the image copy submitted by the prosecution is an admissible evidence on the basis of a result of the authenticity determination of the image copy transmitted by the electronic fingerprint managing apparatus. For example, the court determines the admissibility of the image copy as an evidence when the authenticity of the image copy is verified, and denies the admissibility of the image copy when the authenticity of the image copy is not verified.

A method of verifying intentional erasure of a CCTV camera image, a vehicle black box camera image, or a drone camera image according to an embodiment of the present disclosure is shown below.

As in the above-described embodiment, the database of the electronic fingerprint managing apparatus stores the image hash value, the image storing path, the device identification information, and the image meta information of an image file captured by a CCTV camera, a vehicle black box camera, or a drone camera. An investigative agency such as the prosecution may specify an image storing path based on the device identification information or image meta information to find an image related to a specific criminal investigation. Then, it is checked after linking through the image storing path whether the vehicle black box camera, the CCTV camera, or the drone camera still retains the original image captured at the time of the crime being committed. If it is turned out that the original image does not exist, then the investigative agency may determine that the original image was intentionally erased and may switch the investigation to an evidence concealment investigation. Furthermore, the image hash value and/or storing path, device identification information, and image meta information may be transmitted to the electronic fingerprint managing apparatus and stored therein not only the when an image is generated, but also when an image is erased. Therefore, if the image is intentionally erased, erasure related information such as erasure date and time may be used as evidence.

According to an embodiment of the present disclosure, a method of verifying the authenticity of a copy of a notarized document (for example, a contract).

First, a contract signed or sealed by a contracting party is scanned by a scanner and an image file, an image hash value, an image storing path, device identification information (IP address, MAC address, model name, installation apparatus, installation purpose), and image meta information (hash value generation date and time, generation date and time, name, type, and size of an image file) of the original contract are generated. While the image file is not transmitted, the image hash value, the image storing path, the device identification information, and the image meta information are transmitted to the electronic fingerprint managing apparatus and stored therein. As not only an image hash value of the original contract image file, but also the storing path, image file name, generation time and installation place (for example, a real estate agency) of a generation apparatus, or an installation purpose (notarization) is kept in an reliable electronic fingerprint managing apparatus, a hash value of the contract copy image file at issue is extracted and transmitted to the electronic fingerprint managing apparatus, and compared with the image hash value previously stored in the electronic fingerprint managing apparatus, thereby verifying the authenticity of a copy of the contract.

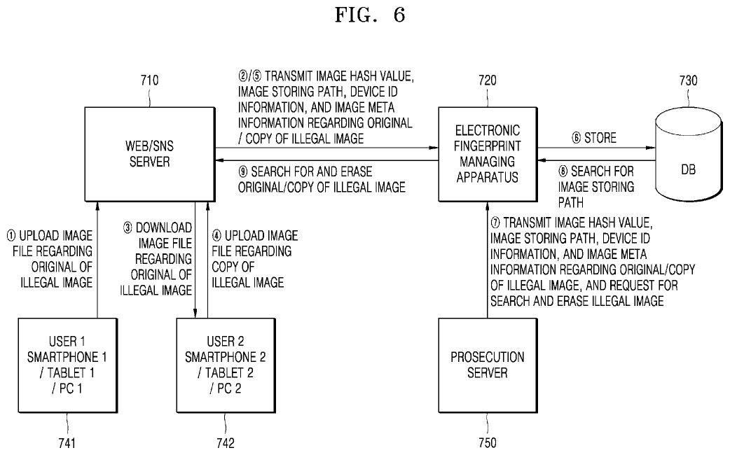

FIG. 6 is a diagram illustrating a method of preventing distribution of an illegally captured image, according to an embodiment of the present disclosure.

When a user 1 uploads an image file (“the original image file”) of an original illegal image generated by a smartphone 1, a tablet 1, or a PC 1 741 to a web or SNS server 710, the web or SNS server 710 may generate an image hash value, an image storing path, device identification information (for example, IP address, MAC address, model name, installation apparatus, and installation purpose), and image meta information (for example, hash value generation date and time, generation date and time, name, type, size, and generation coordinates of the image file) of the original image file, transmit the data to an electronic fingerprint managing apparatus 720, and store the data in a database 730.

Likewise, when all users upload or download an image file to or from the web or SNS server 710, the image hash value, the image storing path, the device identification information, and the image meta information regarding the image file may be generated in the web or SNS server 710, transmitted to the electronic fingerprint managing apparatus 720, and kept in the database 730.

Here, the image file may be a duplicate image file that is a simple downloaded or uploaded original image file, an excerpt image file that is a portion of the original image file, or a synthesized image file. The image hash value of an image file may mean only a hash value of the image file itself, but the image hash value may be stored together with a hash value, storing path, device identification information, and/or the original meta information of the original image file from which the image file is derived. Accordingly, the correlation of all image files derived from the original image file may be traced.

When search or erasure of all illegally captured images is requested while transmitting the image hash value, and/or the storing path, the device identification information, and the image meta information of the original or copy of the illegally captured images obtained by a prosecution server 750 to the electronic fingerprint managing apparatus 720, all related images that are copied, excerpted, or synthesized from the original illegal image may be specified with reference to the information and erased by linking through the storing path.

According to an embodiment of the present disclosure, history management of a CCTV image during a life cycle from creation to erasure may be possible.

First, when an image captured by a CCTV camera is generated in the form of a file, the image hash value, the image storing path, the device identification information, and the image meta information may be transmitted to the electronic fingerprint managing apparatus and kept therein. Similarly, these information about the image may be transmitted to the electronic fingerprint managing apparatus and kept therein when an image is (i) stored in a storage devices, such as NVR/VMS capable of receiving and separately storing, searching, and playing back, in the form of a file, (ii) provided to a third party by backing up a certain image file or a portion thereof in a forensic USB, (iii) erased, (iv) modified, or (v) composited. Furthermore, the image hash value may be stored by additionally including a hash value and/or a storing path, device identification information, and the original meta information of the original image file from which the image file is derived.

Thus, the electronic fingerprint managing apparatus may check whether an image maintains integrity or originality throughout the full cycle and an image is derived (storing, copying, editing, composition, or erasure). Also, the subject and date and time of such an action on the basis of the image hash value and the image meta information, can be verified.

While the embodiments of the present disclosure have been described above, it will be apparent to those of ordinary skill in the art that the present disclosure is not limited thereto and may be embodied in many different forms without departing from the spirit or scope of the present disclosure. Accordingly, the above-described embodiments should be considered as illustrative rather than restrictive, and thus, the present disclosure is not limited to the above description and changes may be made therein within the scope of the appended claims and equivalents thereof.

### INDUSTRIAL APPLICABILITY

The present disclosure is applicable to a method, apparatus and system for managing an electronic fingerprint of an electronic file.

What is claimed is:

1. A method of managing an original electronic fingerprint of an original electronic file, the method comprising:
receiving an original electronic fingerprint of an original electronic file from an original electronic file generation apparatus generating the original electronic file via a communication network, separately from the original electronic file,
wherein the original electronic file is not received when the original electronic fingerprint of the original electronic file is received.

2. The method of claim 1, further comprising:
receiving, at least one of an original storage path information of the original electronic file, a first identifier of the original electronic file generation apparatus and an original meta information of the original electronic file, together with the original electronic fingerprint from the original electronic file generation apparatus.

3. The method of claim 1, wherein the original electronic fingerprint is generated when the original electronic file is generated or when at least part of the original electronic file is backed up.

4. The method of claim 2, further comprising storing at least one of the original storage path information of the original electronic file, the first identifier of the original electronic file generation apparatus and the original meta information of the original electronic file, which are received from the original electronic file generation apparatus, in a memory unit to be mapped to the original electronic fingerprint.

5. The method of claim 2, wherein the first identifier comprises at least one among an Internet protocol (IP) address, a media access control (MAC) address, an identification, an installation place, an installation purpose, and a model name of the original electronic file generation apparatus.

6. The method of claim 2, further comprising requesting the original electronic file generation apparatus to provide the original electronic file on the basis of the original storage path information of the original electronic file, which is received from the original electronic file generation apparatus.

7. The method of claim 1, wherein the original electronic fingerprint comprises:
a first original electronic fingerprint generated by the original electronic file generation apparatus during the generation of the original electronic file; and
a second original electronic fingerprint generated when the original electronic file generated by the original electronic file generation apparatus is changed or deleted.

8. The method of claim 1, further comprising:
receiving a derived electronic fingerprint of a derived electronic file from a derived electronic file generation apparatus generating the derived electronic file via the network, separately from the derived electronic file, the derived electronic file being derived from the original electronic file; and
outputting a result of comparing the original electronic fingerprint and the derived electronic fingerprint with each other.

9. An apparatus for managing an original electronic fingerprint for an electronic device, the apparatus comprising:
a communication unit configured to receive an original electronic fingerprint of an original electronic file from an original electronic file generation apparatus generating the original electronic file via a communication network, separately from the original electronic file; and
a memory unit configured to store the original electronic fingerprint,
wherein the original electronic file is not received when the original electronic fingerprint of the original electronic file is received.

10. The apparatus of claim 9, wherein the communication unit is further configured to receive at least one of an original storage path information of the original electronic file, a first identifier of the original electronic file generation apparatus and an original meta information of the original electronic file, together with the original electronic fingerprint from the original electronic file generation apparatus.

11. The apparatus of claim 9, wherein the original electronic fingerprint is generated when the original electronic file is generated or when at least part of the original electronic file is backed up.

12. The apparatus of claim 10, further comprising a processor configured to store at least one of the original storage path information of the original electronic file, the first identifier of the original electronic file generation apparatus and the original meta information of the original electronic file, which is received from the original electronic file generation apparatus, in a memory unit to be mapped to the original electronic fingerprint.

13. The apparatus of claim 10, wherein the first identifier comprises at least one among an Internet protocol (IP) address, a media access control (MAC) address, an identification, an installation place, an installation purpose, and a model name of the original electronic file generation apparatus.

14. The apparatus of claim 10, further comprising a processor configured to request the original electronic file generation apparatus to provide the original electronic file on the basis of the original storage path information of the original electronic file, which is received from the original electronic file generation apparatus.

15. The apparatus of claim 9, wherein the original electronic fingerprint comprises:
a first original electronic fingerprint generated by the original electronic file generation apparatus during the generation of the original electronic file; and
a second original electronic fingerprint generated when the original electronic file generated by the original electronic file generation apparatus is changed or deleted.

16. The apparatus of claim 9, wherein the communication unit is further configured to receive a derived electronic fingerprint of a derived electronic file from a derived electronic file generation apparatus generating the derived electronic file via the network, separately from the derived electronic file, the derived electronic file being derived from the original electronic file,
the memory unit is further configured to store the derived electronic fingerprint, and
the apparatus further comprising a processor configured to output a result of comparing the original electronic fingerprint and the derived electronic fingerprint with each other.

17. A system for managing an original electronic fingerprint for an electronic device, the system comprising:
an original electronic file generation apparatus configured to generate an original electronic file and an original electronic fingerprint of the original electronic file; and
an electronic fingerprint management apparatus configured to receive the original electronic fingerprint via a communication network, separately from the original electronic file,
wherein the original electronic file is not received when the original electronic fingerprint of the original electronic file is received.

18. The system of claim 17, wherein the electronic fingerprint management apparatus is further configured to receive at least one of an original storage path information of the original electronic file, a first identifier of the original electronic file generation apparatus and an original meta information of the original electronic file, together with the original electronic fingerprint from the original electronic file generation apparatus.

19. The system of claim 17, wherein the original electronic fingerprint is generated when the original electronic file is generated or when at least part of the original electronic file is backed up.

20. The system of claim 17, wherein the original electronic fingerprint comprises:
a first original electronic fingerprint generated by the original electronic file generation apparatus during the generation of the original electronic file; and
a second original electronic fingerprint generated when the original electronic file generated by the original electronic file generation apparatus is changed or deleted.
